(19) United States
(12) Patent Application Publication
(10) Pub. No.: US 2006/0111493 A1
(43) Pub. Date: May 25, 2006

(54) Photopolymerizable resin composition for sandblast resist

(76) Inventors: Jun-Hyeak Choi, Yongin-city (KR); Kook-Hyeon Han, Sungnam-city (KR); Jung-Hyun Noh, Busanjin-gu (KR)

Correspondence Address: DILWORTH & BARRESE, LLP, 333 EARLE OVINGTON BLVD., UNIONDALE, NY, 11553, US

(21) Appl. No.: 10/526,696

(22) PCT Filed: Sep. 2, 2003
(86) PCT No.: PCT/KR03/01791

§ 371 Date: Nov. 10, 2005

(30) Foreign Application Priority Data
Sep. 3, 2002 (KR) 10-2002-0052692

(51) Int. Cl. C08K 5/103; C08K 5/10

(52) U.S. Cl. 524/317

(57) ABSTRACT

A photopolymerizable resin composition for sandblast resist includes as a photopolymerizable oligomer, a polyalkylene glycol mono(meth)acrylate compound having a terminal alkyl group, a compound selected from polyalkylene glycol di(meth)acrylate compounds, and further a compound selected from urethane compounds having a terminal (meth)acrylate group as derived from a polyether or polyester compound having a terminal hydroxyl group, a diisocyanate compound and a (meth)acrylate compound having a hydroxyl group. The resist containing the photopolymerizable resin composition exhibits much improved reactivity relative to the resist using a urethane compound having a terminal (meth)acrylate group alone or in combination with an unsaturated (meth)acrylate compound, which has been conventionally used for dry films. Particularly, it guarantees remarkable improvement in the damage on the surface of the photopolymerizable resin composition after development for the cured regions, which damage is much serious for the resin composition using a cellulose compound having a carboxyl group as an aqueous alkali-soluble polymer.

### TECHNICAL FIELD

The present invention relates to a photopolymerizable resin composition for sandblast resist and, more particularly, to a photopolymerizable resin composition that includes, as a photopolymerizable oligomer, a (meth)acrylate compound including a copolymer of urethane-based (meth)acrylate and nonurethane-based ethylene oxide and propylene oxide, thereby satisfying the required properties of a dry film resist such as high resolution and high adhesion in accordance with the recent tendency of plasma display panels (PDPs) to maintain high resolution.

### BACKGROUND ART

The dry film resist, which is widely used as a fundamental material for circuit patterning in the fabrication of printed circuit boards, has been variously expanded in its applications in recent years.

There are many efforts to use the dry film resist for those regions that have been conventionally processed on a liquid resist, so the dry film resist is now widely used in the IC packaging, or lead frame or BGA (Ball Grid Array) process. Recently, the dry film photoresist is much used in the patterning process of ITO (Indium Tin Oxide) used as a transparent electrode, or the PDP barrier rib process in the fabrication of PDPs.

The partition forming process on the rear glass substrate of the PDP using a dry film resist (DFR) involves lamination of the dry film resist on a PDP material printed with partitions by a heating roller. In this process, a laminator is used to laminate the photoresist layer of the DFR on the partition material while removing the protective film of the DFR. Typically, the lamination is carried out at a lamination speed of 0.5 to 3.5 m/min, a temperature of 100 to 130° C., and a heating roller pressure of 10 to 90 psi.

Following the lamination process, the resultant glass substrate is kept for 15 minutes or more for the purpose of substrate stabilization and then an exposure is carried out on the photoresist of the DFR using a photomask on which a desired circuit pattern is formed. In this process, a UV radiation on the photomask causes polymerization on the exposed regions of the photoresist by a photoinitiator contained in the photoresist. More specifically, oxygen contained in the photoresist is used up, and then, the activated monomers are polymerized to cause crosslinkage, after which the monomers are more used to cause a polymerization reaction. The unexposed regions of the photoresist are remained without the generation of crosslinkage.

Then, a development process is carried out to remove the unexposed regions of the photoresist. For an alkali-developable dry film resist, an aqueous solution of potassium carbonate or sodium carbonate (0.2 to 1.2 wt. %) is used as a developing solution. In this process, the unexposed regions of the photoresist are washed away by the saponification reaction between the developing solution and the carboxylic acid of the binder polymer in the developing solution, and the cured photoresist regions of the photoresist remain on the surface of the partition material.

The glass substrate on which the dry film resist is patterned as above is subjected to a sandblasting process to form a partition pattern. In the sandblasting process, the dry film pattern formed on the partition pattern functions as a protective layer for preventing ablation of the underlying partition material Subsequently, the stripping process for removing the pattern of the dry film resist and the firing process for curing the partition material are sequentially performed to complete the partition formation.

In the ablation process for removing the UV-cured dry film resist, the partition not fired may collapse during the ablation process when using a NaOH or KOH aqueous solution that is primarily used for the printed circuit boards. This problem can be solved by the use of an amine-based dedicated ablating solution or by the modification of the process. In the case of using an amine-based dedicated ablating solution, however, such a small sample of the dry film resist may get in the surface of the partition due to the use of a grinding material, which problem functions as a serious defective.

In addition, for a lead glass substrate, the surface is so rough as to cause an adhesion problem of the dry film resist by a low conformability, thereby causing a damage of the partition.

The examples of the prior art concerning the resin composition for sandblast resist include Japanese Laid-Open Patent Sho 60-10242 that discloses a resin composition for sandblast resist comprising a urethane compound having a terminal (meta)acrylate group, a monofunctional ethylene-based unsaturated compound, and a photoinitiator; Japanese Laid-Open Patent Sho 55-103554 that discloses a resin composition for sandblast resist comprising an unsaturated polyester, an unsaturated monomer, and a photoinitiator; and Japanese Laid-Open Patent Pyung 2-69754 that discloses a resin composition for sandblast resist comprising a polyvinyl alcohol, and a diazo resin.

These resin compositions, which are all in the liquid state, are difficult to handle and hardly controllable in regard to coating thickness.

Japanese Laid-Open Patent Pyung 6-161097 and Pyung 6-161098 describe a photopolymerizable resin composition that comprises a urethane oligomer having ethylene-based unsaturated double bonds at its molecular terminal group, a cellulose derivative or a compound containing ethylene-based unsaturated double bonds, and a photoinitiator.

Korean Patent No. 198725, U.S. Pat. Nos. 6200733, 5924912 and 6322947, and Japanese Patent Laid-Open Pyung 8-54734, Pyung 11-119430 and 2000-66391 disclose methods for fabricating a sandblast resist comprising a photoinitiator; an alkali-soluble polymer compound; and a urethane compound having a terminal (meta)acrylate group as derived from a polyether or polyester compound having a terminal hydroxyl group, a diisocyanate compound and a (meta)acrylate compound having a hydroxyl group.

According to the above-mentioned methods, the alkali developability is good with high elasticity and flexibility, but the use of the urethane compound having a terminal (meta)acrylate group as a reactive oligomer results in a low reactivity and hence a poor alkali-resistant developability and a low strength of the coating. Accordingly, there is the difficulty in applying the methods to the high-resolution PDPs using the sandblast process.

In other words, the conventional resin composition for sandblast resist comprises a photoinitiator, an alkali-soluble polymer compound, and a urethane compound having a terminal (meta) acrylate group as derived from a polyether or polyester compound having a terminal hydroxyl group, a diisocyanate compound and a (meta)acrylate compound having a hydroxyl group and, if using the urethane compound having a terminal (meta)acrylate group as a reactive oligomer, exhibits a low reactivity and a poor alkali-resistant developability to deteriorate the adherence of the dry film resist and increase the swelling of the dry film resist pattern after development, thereby adversely affecting the resolution. Besides, the above-mentioned alkali-soluble polymer compound included in the resin composition is selected from the group consisting of copolymers of (meta)acrylate and (meta)acrylate ester, and cellulose compounds having carboxyl groups. Particularly, the use of the cellulose compound having carboxyl groups causes an extreme deterioration of chemical resistance to aqueous alkali solutions and results in a serious damage on the patterns formed in the development process, thereby making it difficult to realize the formation of a high-resolution and high-adherence pattern.

Accordingly, the inventors of this invention have studied to solve the problems of the above composition in regard to the remarkable deterioration of the alkali chemical resistance when using both the cellulose compound as a binder polymer and the urethane compound having terminal (meta)acrylate groups as a reactive oligomer, and found out that the use of a specific mono- or multi-functional reactive unsaturated (meta)acrylate in addition to a plasticizer can remarkably increase resolution and alkali chemical resistance, thereby dramatically improving the adhesion of the dryfilm photoresist to complete the present invention.

### DISCLOSURE OF INVENTION

It is an object of the present invention to provide a photopolymerizable resin composition for sandblast resist that has good elasticity and flexibility as required to the sandblast resist, provides a resist layer patterned by photolithography with a high adherence to the surface of the substrate, and exhibits good alkali developability and the short stripping time.

It is another object of the present invention to provide a photopolymerizable resin composition for sandblast resist that provides high resolution and high adherence as required to the dry film in accordance with the recent tendency of PDPs to maintain high resolution, by using a (meta)acrylate compound containing a copolymer of urethane-based (meta)acrylate and non-urethane-based ethylene oxide and propylene oxide, and a plasticizer.

To achieve the objects of the present invention, there is provided a photopolymerizable resin composition for sandblast resist that includes an aqueous alkali-soluble binder polymer, photopolymerizable oligomer, a photoinitiator, and an additive. The photopolymerizable oligomer includes at least one selected from a polyalkylene glycol mono(meta)acrylate compound having a terminal alkyl group as selected from the group consisting of compounds represented by the following formulas I to IV, and a polyalkylene glycol di(meta)acrylate compound as selected from the group consisting of compounds represented by the following formulas V to VIII. 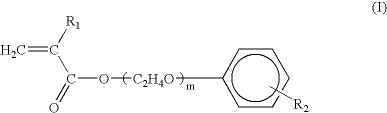
In the above formula, R₁ is hydrogen or methyl; R₂ is an alkyl group having 1 to 30 carbon atoms; and m is an integer from 1 to 30, 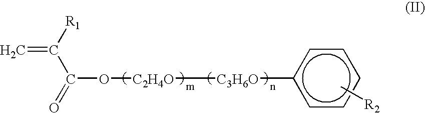
In the above formula, R₁, R₂ and m are as defined in the formula I; and n is an integer from 1 to 30, where n+m is equal to an integer from 2 to 50, 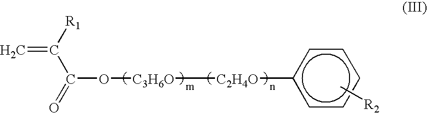
In the above formula, R₁, R₂, m and n are as defined in the formula II, 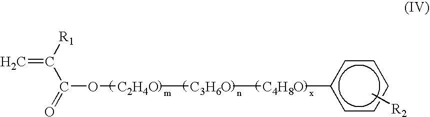
In the above formula, R₁, R₂, m and n are as defined in the formula II; and x is an integer from 1 to 30, where m+n+x is equal to an integer from 6 to 30, 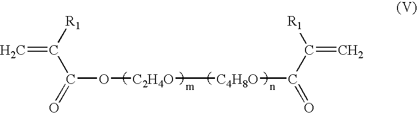
In the above formula, R₁ is hydrogen or methyl; m is an integer from 1 to 30; and n is an integer from 1 to 30, where m+n is equal to an integer from 3 to 30, 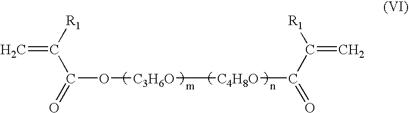
In the above formula, R₁, m and n are as defined in the formula V, 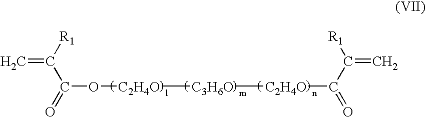
In the above formula, R₁, m and n are as defined in the formula V; and 1 is an integer from 1 to 30, where l+m+n is equal to an integer from 3 to 50, 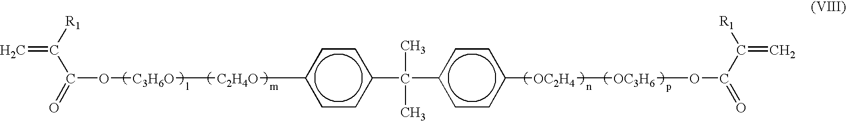
In the above formula, R₁, m, n and 1 are as defined in the formula VII; and p is an integer 15 from 1 to 30, where l+m+n+p is equal to an integer from 4 to 40,

In addition, the photopolymerizable resin composition for sandblast resist according to the present invention includes a mixture of the above-stated photopolymerizable oligomer and at least one selected from urethane compounds having a terminal (meta)acrylate group as represented by the following formula IX and derived from a polyether or polyester compound having a terminal hydroxyl group, a diisocyanate compound and a (meta)acrylate compound having a hydroxyl group. 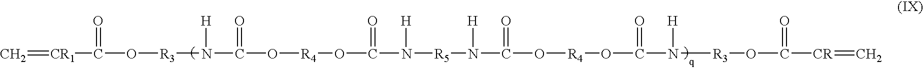
In the above formula, R₁ and R are the same or different and include hydrogen or methyl; R₃ is alkylene or alkylene ether; R₄ is a divalent residual group derived by removing a diisocyanate derivative of two isocyanate groups; R₅ is a divalent residual group derived by removing a diol derivative of a hydroxyl group, the diol derivative having a terminal hydroxyl group and polyether or polyester as the structure of its main chain; and q is an integer from 1 to 10.

The present invention is directed to a photopolymerizable resin composition for sandblast resist excellent in alkali developability and, more particularly, to a photopolymerizable resin composition for sandblast resist excellent in alkali chemical resistance to provide a very high adherence of the resist after the development process. Additionally, the sandblast resist is excellent in flexibility and elasticity and capable of forming fine patterns.

In the prior art (Korean Patent No. 198725, and U.S. Pat. Nos. 6,200,733; 5,924,912; and 6,322,947) using a polyurethane compound having at least one (meta)acrylate group as a photopolymerizable oligomer in an attempt to enhance the sandblast resistance, the compounds containing urethane groups are excellent in elasticity and flexibility with a low reactivity, and the compounds using a cellulose derivative containing carboxyl groups as a binder polymer deteriorates alkali chemical resistance to the developing solution and reduces the thin film adherence. In Korean Patent No. 198725, the reason why the content of the photopolymerizable monomers (mono- or multi-functional monomers) used as an optional material is specifically limited to less than 20 parts by weight with respect to 100 parts by weight of the polyurethane compound having a terminal (meta)acrylate group is because the use of the excess of these photopolymerizable monomers may result in a brittle resist after the UV-curing process to deteriorate the sandblast resistance.

Accordingly, the present invention uses a photopolymerizable compound having specific ethylene-based unsaturated groups as well as a polyurethane compound having at least one (meta)acrylate group as a photopolymerizable oligomer, and adds a plasticizer to improve elasticity and flexibility of the dry film photoresist after the exposure process and increase reactivity and chemical resistance to the developing solution, thereby achieving high adherence and high resolution.

The term “photopolymerizable resin composition” as used herein refers to a photoresist layer interposed between a polyethylene terephthalate (PET) film and a polyethylene (PE) film. The photoresist layer includes (a) a photoinitiator, (b) an alkali-developable binder polymer, (c) a photopolymerizable oligomer, and (d) different additives.

The photopolymerizable resin composition is required to be excellent in adherence to the substrate especially during the sandblasting process and to have good elasticity and flexibility for mechanical impact resistance to sandblasting.

The individual components of the photopolymerizable resin composition are as follows.

(a) Photoinitiator

The term “photoinitiator” as used herein refers to a material initiating the chain reaction of the photopolymerizable oligomer by UV or other radiations. The photoinitiator is a compound that plays an important role in curing the dry film resist.

The specific examples of the compound that can be used as the photoinitiator may include anthraquinone derivatives such as 2-methyl anthraquinone, or 2-ethyl anthraquinone; or benzoin derivatives such as benzoin methyl ether, benzophenone, phenanthrene, or 4,4′-bis-(dimethylamino)benzophenone.

Besides, the photoinitiator can be any one compound selected from 1-hydroxycyclohexylphenyl ketone, 2,2-dimethoxy-1,2-diphenylethane-1-one, 2,-mthyl-1-[4-(methylthio)phenyl]-2-morpolynopropane-1-one, 2-benzyl-2-dimethylamino-1-[4-morpolynophenyl]butane-1-one, 2-hydroxy-2-methyl-1-phenylpropane-1-one, 2,4,6-trimethylbenzoyldiphenylphosphine oxide, 1-[4(2-hydroxymethoxy)phenyl]-2-hydroxy-2-methylpropane-1-one, 2,4-diethylthioxanetone, 2-chlorothioxanetone, 2,4-dimethylthioxanetone, 3,3-dimethyl-4-methoxybenzophenone, benzophenone, 1-chloro-4-propoxythioxanetone, 1-(4-isopropylphenyl)2-hydroxy-2-methylpropane-1-one, 1-(4-dodecylphenyl)-2-hydroxy-2-methylpropane-1-one, 4-benzoyl-4′-methyldimethylsulfide, 4-dimethylaminobenzoic acid, methyl 4-dimethylaminobenzoate, ethyl 4-dimethylaminobenzoate, butyl 4-dimethylaminobenzoate, 2-ethylhexyl 4-dimethylaminobenzoate, 2-isoamyl 4-dimethylaminobenzoate, 2,2-diethoxyacetophenone, benzylketone dimethylacetal, benzylketone β-methoxy diethylacetal, 1-phenyl-1,2-propyldioxime-o,o′-(2-carbonyl)ethoxyether, methyl o-benzoylbenzoate, bis[4-dimethylaminophenyl]ketone, 4,4′-bis(diethylamino)benzophenone, 4,4′-dichlorobenzophenone, benzyl, benzoin, methoxybenzoin, ethoxybenzoin, isopropoxybenzoin, isobutoxybenzoin, tert-butoxybenzoin, p-dimethylaminoacetophenone, p-tert-butyltrichloroacetophenone, p-tert-butyldichloroacetophenone, thioxanetone, 2-methylthioxanetone, 2-isopropylthioxanetone, dibenzosuberone, a,a-dichloro-4-phenoxyacetophenone, and pentyl 4-dimethylaminobenzoate. The content of the photoinitiator is preferably 2 to 10 wt. % based on the total weight of the photopolymerizable resin composition.

(b) Aqueous Alkali-Soluble Polymer Compound

In the photopolymerizable resin composition of the present invention, the aqueous alkali-soluble polymer compound is an alkali-soluble polymer resin selected from the group consisting of a copolymer of (meta)acrylate and (meta)acrylate ester, and a cellulose resin containing carboxyl groups.

More specifically, the copolymer of (meta)acrylate and (meta)acrylate ester is a copolymerized acrylate polymer obtained by copolymerization of at least two monomers selected from the group consisting of: methyl acrylate, methyl methacrylate, ethylacrylate, methyl methacrylate, butyl acrylate, butyl methacrylate, acrylic acid, methacrylic acid, 2-hydroxy ethyl acrylate, 2-hydroxy ethyl methacrylate, 2-hydroxy propyl acrylate, 2-hydroxy propyl methacrylate, acrylamide, methacrylamide, styrene, or a-methyl styrene. The linear acrylate polymer has an average molecular weight of 20,000 to 150,000 and a glass transition temperature of 20 to 150 ° C in consideration of the coatability, and conformability of the dry film resist, and the mechanical strength of the resist itself after circuit formation. Preferably, the content of the carboxylate binder polymer is 20 to 80 wt. % with respect to the total weight of the photopolymerizable resin composition.

The preferred copolymers of (meta)acrylate and (meta)acrylate ester are Hi-pearl M-0619 and M-0919 having a relatively low glass transition temperature as supplied by Negami chemical industrial co., LTD.

The preferred examples of the cellulose resin containing carboxyl groups may include hydroxyethylcarboxymethylcellulose, celluloseacetatehydrogenphthalate, or hydroxypropylmethylcellulosephthalate. Hydroxymethylcellulosephthalate is most preferred in the aspect of stability, high quality of dry films, high coatability, and good alkali-developability and ablativeness.

The binder polymers as used in the examples are as follows: Hi-pearl M-0619 (molecular weight 60,200; Mw/Mn 1.93; acid value 124.5 mgKOH/g); KOLON BP-120 (molecular weight 75,400; Mw/Mn 1.93; acid value 124.5 mgKOH/g); Celluloseacetatehydrogenphthalate (CAP); ALDRICH (catalog. No. 32,807-3); hydroypropylmethylcellulosephthalate (HPMCP); and ALDRICH (catalog. No. 43,519-8).

(c) Photopolymerizable Oligomer

The core of the present invention, the photopolymerizable oligomer includes at least one of (c-1) a polyalkylene glycol mono(meta)acrylate compound having a terminal alkyl group as selected from the group consisting of compounds represented by the formulas I to VI; (c-2) a polyalkylene glycol di(meta)acrylate compound selected from the group consisting of compounds represented by the formulas V to VIII; and (c-3) a urethane compound having a terminal (meta)acrylate group as represented by the formula IX and derived from a polyether or polyester compound having a terminal hydroxyl group, a diisocyanate compound and a (meta)acrylate compound having a hydroxyl group.

When using at least one of the components (c-1) and (c-2) in combination with the component (c-3) as a photopolymerizable oligomer, the component (c-1) or (c-2) is preferably used in an amount of 5 to 70 parts by weight with respect to 100 parts by weight of the compound (c-3). The content of the component (c-1) or (c-2) exceeding 70 parts by weight with respect to 100 parts by weight of the component (c-3) decreases the elasticity of the dry film resist and reduces the sandblast resistance.

Particularly, when using the components (c-1) and (c-2) as a photopolymerizable oligomer, the dry film becomes hard after being cured by UV radiation and loses flexibility that is the driving force of the resistance to the mechanical impact of sandblasting. To solve this problem, an appropriate plasticizer is preferably added.

The compounds used in the preparation of the oligomer represented by the formula IX are as follows: The specific examples of the preferred diisocyanate compound reactive to the diol derivative including the polyester or polyether compound group may include aliphatic or aliphatic cyclic diisocyanate compounds and their aromatic cyclic diisocyanate compounds, such as dimethylenediisocyanate, trimethylenediisocyanate, tetramethylenediisocyanate, pentamethylenediisocyanate, hexamethylenediisocyanate, heptamethylenediisocyanate, 1,5-diisocyanato-2,2-dimethylpentane, octamethylenediisocyanate, 1,6-diisocyanato-2,5-dimnethylhexane, 1,5-diisocyanato-2,2,4-trimethylpentane, nonamethylenediisocyanate, 1,6-diisocyanato-2,2,4-trimethylhexane, 1,6-diisocyanato-2,4,4-trimethylhexane, decarnethylenediisocyanate, isophoronediisocyanate, 2,4-toluene diisocyanate, 2,6-toluene diisocyanate, diphenylpentane-4,4′-diisocyanate, diphenylmethane-2,4′-diisocyanate, diphenylmethane-2,2′-diisocyanate, 1-isocyanato-3-isocyanatomethyl-3,5,5-trimethyl-cyclohexane, 1,5-naphthalene diisocyanate, or 1,4-phenylene diisocyanate.

The term “polyether” as used in the diol derivative including a polyester or polyether group reactive to the diisocyanate compound refers to homo- or copolymers derived by the ring-opening reaction of ethylene oxide, propylene oxide, and tetrahydrofuran. The term “polyester” as used in the diol derivative refers to polyester compounds derived by the ring-opening polymerization of lactone, such as δ-valerolactone, ε-carprolactone, β-propiolactone, α-methyl-β-propiolactone, β-methyl-β-propiolactone, α,α-dimethyl-β-propiolactone, or β,β-dimethyl-β-propiolactone. The term “diol derivative having a terminal hydroxyl group and polyether or polyester as the structure of its main chain as used herein refers to diol compounds such as ethylene glycol, diethylene glycol, triethylene glycol, 1,2-propylene glycol, or dipropylene glycol; and dicarboxylate derivative compounds such as adipate, or phthalate.

The photopolymerizable resin composition, which is prepared as described above by using, as a photopolymerizable oligomer, at least one of (c-1) the polyalkylene glycol mono(meta)acrylate compound having a terminal alkyl group, (c-2) the polyalkylene glycol di(meta)acrylate compound, and (c-3) the urethane compound having a terminal (meta)acrylate group as derived from a polyether or polyester compound having a terminal hydroxyl group, a diisocyanate compound and a (meta)acrylate compound having a hydroxyl group, exhibits remarkably improved reactivity relative to the resin composition using a urethane compound having a terminal (meta)acrylate group alone as a photopolymerizable oligomer. In this case, particularly, the surface damage of the photopolymerizable resin composition after development for the UV-cured regions can be greatly improved relative to the resin composition using a cellulose compound having a carboxyl group as an aqueous alkali-soluble polymer compound, thereby realizing high resolution and the fabrication of high-resolution PDPs.

The weight ratio of the aqueous alkali-soluble polymer compound to the photopolymerizable oligomer is preferably in the range of 70:30 to 5:95. If it deviates from the above range, then the coating characteristic of the dry film may deteriorate abruptly, or edge fusion called “cold flow” may occur.

The use of the components (c-1) and (c-2) as a photopolymerizable oligomer may have the above-mentioned strong points, but deteriorate the flexibility of the dry film and hence the resistance to the mechanical impact of sandblasting. To solve this problem, as described above, a plasticizer is additionally used.

The plasticizer available in the present invention is as follows.

To enhance flexibility and coating performance of the dry film before and after TV curing, the plasticizer is used for the photopolymerizable resin composition. The primarily used plasticizer may include phthalic esters such as dibutyl phthalate, diheptyl phthalate, dioctyl phthalate, or diallyl phthalate; glycol esters such as triethylene glycol diacetate, or tetraethylene glycol diacetate; acid amides such as p-toluenesulfonamide, benzenesulfonamide, or N-n-butyl-benzenesulfonamide; aliphatic dibasic acid esters such as diisopropyl adipate, dioctyl azelate, or dibutyl maleate; phosphates such as triphenyl phosphate; and tributyl citrate, glycerol triacetate, or dioctyl butyl lauryl 4,5-diepoxycyclohexane-1,2-dicarboxylate. The content of the plasticizer is, based on the solid weight of the photopolymerizable resin composition, suitably about 0.01 to 50 wt. %, more preferably 0.01 to 20 wt. %. Here, the plasticizer is not specifically limited to the above-mentioned compounds.

(d) Additives

The additives as used herein may include a thermal polymerization inhibitor, dyes, a discoloring agent, an adherence enhancer, and a plasticizer. The specific examples of the additives are disclosed in U.S. Pat. No. 5,300,401.

### BEST MODE FOR CARRYING OUT THE INVENTION

Hereinafter, the present invention will be described in detail by way of the following examples, which are not intended to limit the scope of the present invention.

The photopolymerizable oligomers used in the following examples and comparative examples are as follows:

5OADET-1800: Compound represented by the formula (V), where R₁=H, m=20, and n=16;

70ANEP-550: Compound represented by the formula (II), where R₂=C₉H₁₉, m=9, and n=3;

30PDC-950BH: Compound represented by the formula (VII), where 1, n=6, m=12, weight average molecular weight=1130;

43PDBPE-800B: Compound represented by the formula (VIII), where 1, m, n, p=4;

PU-280, PU-210: Compounds represented by the formula (IX);

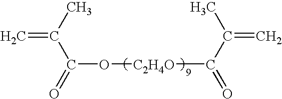

9G:

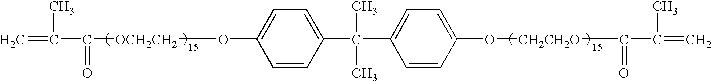

### EXAMPLES 1 to 4 AND COMPARATIVE EXAMPLES 1 AND 2

The Examples of the present invention exemplify the resin composition suggested in the present invention; the Comparative Example 1 employs the polyurethane compound having a terminal unsaturated (meta)acrylate group and an unsaturated (meta)acrylate compound diverting from the category of the specific reactive oligomer suggested in the present invention; and the Comparative Example 2 employs, as a reactive oligomer, an unsaturated (meta)acrylate compound diverting from the category of the specific reactive oligomer suggested in the present invention.

The specified compositions are presented in Tables 1 to 6.

TABLE 1
Example 1

| | | Content | |
|---|---|---|---|
| | | (parts by | |
| Composition | | weight) | Ref. |
| Aqueous alkali- | CAP (Aldrich) | 160.0 | 25 wt. % |
| soluble polymer | | | in MEK |
| compound | | | |
| Photoinitiator | Benzophenone | 2.0 | |
| | 4,4′-(bisdiethylamino) | 3.0 | |
| | benzophenone | | |
| | Leuko Crystal Violet | 3.0 | |
| | Toluenesulfonate | 0.5 | |
| | 1 hydrate | | |
| | Diamond Green GH | 0.5 | |
| Photopolymerizable | 50ADET-1800 | 10.0 | 40.0 |
| oligomer | (NOF corportation) | | |
| | PU-280 (Miwon | 20.0 | |
| | commercial co., LTD.) | | |
| | PU-210 (Miwon | 10.0 | |
| | commercial co., LTD.) | | |
| Plasticizer | Triethylene glycol | 3.0 | |
| | diacetate (Aldrich) | | |
| Solvent | Methylethylketone | 13.0 | |

TABLE 2
Example 2

| | | Content (parts | |
|---|---|---|---|
| Composition | | by weight) | Ref. |
| Aqueous alkali- | CAP (Aldrich) | 160.0 | 25 wt. % |
| soluble polymer | | | in MEK |
| compound | | | |
| Photoinitiator | Benzophenone | 2.0 | |
| | 4,4′-(bisdiethylamino) | 3.0 | |
| | benzophenone | | |
| | Leuko Crystal Violet | 3.0 | |
| | Toluenesulfonate | 0.5 | |
| | 1 hydrate | | |
| | Diamond Green GH | 0.5 | |
| Photopolymerizable | 50ADET-1800 | 20.0 | 40.0 |
| oligomer | (NOF corportation) | | |
| | 70ANEP-550 | 20.0 | |
| | ((NOF corportation) | | |
| Plasticizer | Triethylene glycol | 3.0 | |
| | diacetate (Aldrich) | | |
| Solvent | Methylethylketone | 20.0 | |

TABLE 3
Example 3

| | | Content | |
|---|---|---|---|
| | | (parts of | |
| Composition | | weight) | Ref. |
| Aqueous alkali- | CAP (Aldrich) | 160.0 | 25 wt. % |
| soluble polymer | | | in MEK |
| compound | | | |
| Photoinitiator | Benzophenone | 2.0 | |
| | 4,4′-(bisdiethylamino) | 3.0 | |
| | benzophenone | | |
| | Leuko Crystal Violet | 3.0 | |
| | Toluenesulfonate | 0.5 | |
| | 1 hydrate | | |
| | Diamond Green GH | 0.5 | |
| Photopolymerizable | 30PDC-950BH | 10.0 | 40.0 |
| oligomer | ((NOF corportation) | | |
| | PU-280 (Miwon | 20.0 | |
| | commercial co., LTD.) | | |
| | PU-210 (Miwon | 10.0 | |
| | commercial co., LTD.) | | |
| Plasticizer | Triethylene glycol | 3.0 | |
| | diacetate (Aldrich) | | |
| Solvent | Methylethylketone | 13.0 | |

TABLE 4
Example 4

| | | Content | |
|---|---|---|---|
| | | (parts | |
| Composition | | by weight) | Ref. |
| Aqueous alkali- | CAP (Aldrich) | 160.0 | 25 wt. % |
| soluble polymer | | | in MEK |
| compound | | | |
| Photoinitiator | Benzophenone | 2.0 | |
| | 4,4′-(bisdiethylamino) | 3.0 | |
| | benzophenone | | |
| | Leuko Crystal Violet | 3.0 | |
| | Toluenesulfonate 1 hydrate | 0.5 | |
| | Diamond Green GH | 0.5 | |
| Photopolymerizable | 43PDBPE-800B | 10.0 | 40.0 |
| oligomer | (NOF corportation) | | |
| | PU-280 ((Miwon | 20.0 | |
| | commercial co., LTD.) | | |
| | PU-210 ((Miwon | 10.0 | |
| | commercial co., LTD.) | | |
| Plasticizer | Triethylene glycol | 3.0 | |
| | diacetate (Aldrich) | | |
| Solvent | Methylethylketone | 13.0 | |

TABLE 5
Comparative Example 1

| | | Content | |
|---|---|---|---|
| | | (parts | |
| Composition | | by weight) | Ref. |
| Aqueous alkali- | CAP (Aldrich) | 160.0 | 25 wt. % |
| soluble polymer | | | in MEK |
| compound | | | |
| Photoinitiator | Benzophenone | 2.0 | |
| | 4,4′-(bisdiethylamino) | 3.0 | |
| | benzophenone | | |
| | Leuko Crystal Violet | 3.0 | |
| | Toluenesulfonate | 0.5 | |
| | 1 hydrate | | |
| | Diamond Green GH | 0.5 | |
| Photopolymerizable | 9G ((Shin-nakamura | 10.0 | |
| oligomer | chemical co., LTD) | | |
| | PU-280 (Miwon | 20.0 | |
| | commercial co., LTD.) | | |
| | PU-210 (Miwon | 10.0 | |
| | commercial co., LTD.) | | |
| Plasticizer | Triethylene glycol | 3.0 | |
| | diacetate (Aldrich) | | |
| Solvent | Methylethylketone | 20.0 | |

TABLE 6
Comparative Example 2

| | | Content | |
|---|---|---|---|
| | | (parts | |
| Composition | | by weight) | Ref. |
| Aqueous alkali- | CAP (Aldrich) | 160 | 25 wt. % |
| soluble polymer | | | in MEK |
| compound | | | |
| Photoinitiator | Benzophenone | 2.0 | |
| | 4,4′-(bisdiethylamino) | 3.0 | |
| | benzophenone | | |
| | Leuko Crystal Violet | 3.0 | |
| | Toluenesulfonate 1 hydrate | 0.5 | |
| | Diamond Green GH | 0.5 | |
| Photopolymerizable | 9G (((Shin-nakamura | 12.5 | |
| oligomer | chemical co., LTD) | | |
| | BPE-1300N | 12.5 | |
| | (((Shin-nakamura | | |
| | chemical co., LTD) | | |
| Plasticizer | Triethylene glycol | 3.0 | |
| | diacetate (Aldrich) | | |
| Solvent | Methylethylketone | 20.0 | |

The mixed solution of each photopolymerizable resin composition was prepared according to the Tables 1 to 6, coated in a uniform thickness (40 μm) on the PET film of 20 μm with a coating bar, and dried at 80° C. in a hot air oven for about 5 minutes. Then, the PE film was laminated on the dried coating to complete a sandblast resist.

The sandblast resist thus completed was removed of the PE film on glass substrate and laminated by using a heating pressure roller. Using a photomask of 10 to 200 μm which is divided in 5 μm, the adherence and resolution of the resist were measured. The pattern of the photomask was Line/Space=x: 400 (unit: μm) for the adherence, and Line/Space=400: y (unit: μm) for resolution. The sensitivity used as the measurement of reactivity was measured for the resist using the 21-step tablet (Stouffer Graphic Arts Equipment Co.,). For the measurement of the important property of the sandblast resist, sandblast resistance, the PE film was removed, and dry film was laminated on the glass substrate and exposed to an irradiation of 100 mJ/cm² (the actual exposure energy of the dry film=UV energy measured under the photomask) with 5 kW collimated light UV exposure unit of 5 kW. After removal of the PET film, a grinding agent was sprayed with a pressure of 1.5 kg/cm² by a sandblast nozzle and the time taken for complete removal of the coating of the dry film was measured. Here, the distance between the sandblast nozzle and the substrate was 1 cm.

For the measurement of the resistance to the developing solution in the cured region, the surface of the cured region was rubbed manually without drying out the rinse solution after development and the dissolution degree of the resist was measured. In this case the measurement was appraised as “small” for the slight dissolution of the surface of the cured region, “large” for the complete dissolution, and “middle” for the meddle degree between “small” and “large”.

The results are presented in Table 7.

TABLE 7

| | Exposure | | | | | | |
|---|---|---|---|---|---|---|---|
| | Energy^{*1} | A1 | A2 | A3 | A4 | B1 | B2 |
| Damage by developing solution | | Middle | Small | Small | Small | Large | Small |
| on cured surface after | | | | | | | |
| development | | | | | | | |
| Sandblasting resistance (sec) | | 180 | 150 | 160 | 170 | 130 | 90 |
| Sensitivity^{*2} | 70 | 8/21 | 8.5/21 | 7.5/21 | 8.5/21 | 6/21 | 9/21 |
| | 100 | 9/21 | 9.5/21 | 8.5/21 | 9.5/21 | 6.5/21 | 10.5/21 |
| | 150 | 10/21 | 11/21 | 9.5/21 | 11/21 | 7.5/20 | 13/21 |
| Resolution^{*3} | 30 | 40 | 35 | 35 | 30 | 55 | 80 |
| (μm) | 40 | 47 | 40 | 40 | 35 | 65 | 100 |
| | 50 | 60 | 45 | 45 | 40 | 75 | 130 |
| Thin film adherence | 30 | 40 | 30 | 35 | 30 | 50 | 30 |
| (μm) | 40 | 30 | 25 | 30 | 25 | 40 | 25 |
| | 50 | 25 | 20 | 25 | 20 | 30 | 25 |

^{*1}Exposure energy under artwork, i.e., the exposure energy (mJ/cm²) to dry film photoresist.
^{*2}Sensitivity measured with Stouffer 21 step tablet.
^{*3}Resolution measured with the spaces between circuit lines as 1:1.
*Lamination condition of dry film photoresist: HAKUTO MACH 610i; temperature 115° C.; pressure 4 kgf/cm²; speed 2.5 m/min; preheating temperature 80° C.
*Exposure condition of dry film photoresist: Perkin-Elmer ™ OB7120 (parallel radiation exposure equipment).
*Development condition of dry film photoresist: Developing solution Na₂CO₃ 0.5 wt. %; temperature 30° C.; spray pressure 1.5 kgf/cm²; rupture point 65%.

### INDUSTRIAL APPLICABILITY

As described above in detail, the photopolymerizable resin composition of the present invention, which comprises, as a photopolymerizable oligomer, a polyalkylene glycol mono(meta)acrylate compound having a terminal alkyl group, a compound selected from polyalkylene glycol di(meta)acrylate compounds, and a compound selected from urethane compounds having a terminal (meta)acrylate group as derived from a polyether or polyester compound having a terminal hydroxyl group, a diisocyanate compound and a (meta)acrylate compound having a hydroxyl group, and further a plasticizer, exhibits much improved reactivity relative to the resin composition using an urethane compound having a terminal (meta)acrylate group alone or in combination with an unsaturated (meta)acrylate compound conventionally used for dry films, and particularly guarantees remarkable improvement in the damage on the surface of the resin composition after development for the cured regions, which damage is much serious for the resin composition using a cellulose compound having a carboxyl group as an aqueous alkali-soluble polymer. Consequently, a sandblast resist for realization of high resolution or fabrication of high-resolution PDPs can be provided according to the present invention.

1. In a photopolymerizable resin composition for sandblast resist, which includes an aqueous alkali-soluble binder polymer, a photopolymerizable oligomer, a photoinitiator, and an additive,
the photopolymerizable oligomer comprising at least one of a polyalkylene glycol mono(meth)acrylate compound having a terminal alkyl group as selected from the group consisting of compounds represented by the following formulas I to IV, or a polyalkylene glycol di(meth)acrylate compound as selected from the group consisting of compounds represented by the following formulas V to VIII, 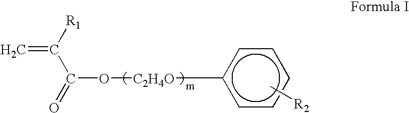
wherein R₁ is hydrogen or methyl; R₂ is an alkyl group having 1 to 30 carbon atoms; and m is an integer from 1 to 30, 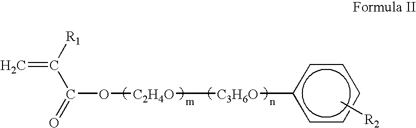
wherein R₁, R₂ and m are as defined in the formula I; and n is an integer from 1 to 30, where n+m is equal to an integer from 2 to 50, 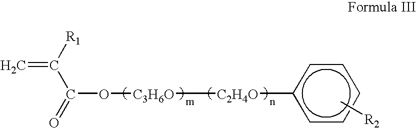
wherein R₁, R₂, m and n are as defined in the formula II, where n+m is equal to an integer from 2 to 50, 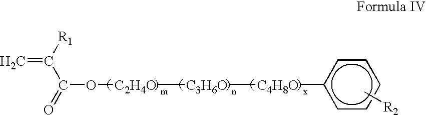
wherein R₁, R₂, m and n are as defined in the formula II; and x is an integer from 1 to 30, where m+n+x is equal to an integer from 6 to 30, 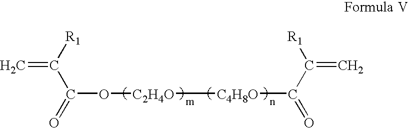
wherein R₁ is hydrogen or methyl; m is an integer from 1 to 30; and n is an integer from 1 to 30, where m+n is equal to an integer from 3 to 4 40, 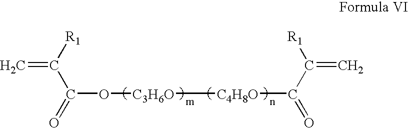
wherein R₁, m and n are as defined in the formula V, where m+n is equal to an integer from 3 to 40, 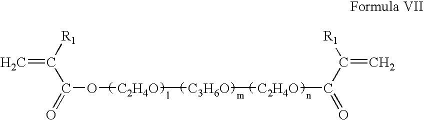
wherein R₁, m and n are as defined in the formula V; and 1 is an integer from 1 to 30, where l+m+n is equal to an integer from 3 to 50, 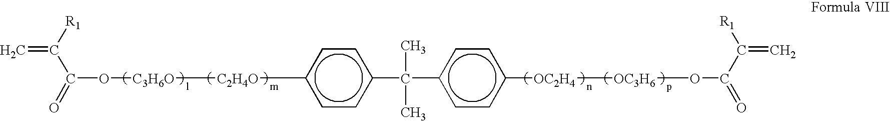
wherein R₁, m, n and 1 are as defined in the formula VII; and p is an integer from 1 to 30, where l+m+n+p is equal to an integer from 4 to 40.

2. The photopolymerizable resin composition for sandblast resist as claimed in claim 1, wherein the weight ratio of the aqueous alkali-soluble polymer compound to the photopolymerizable oligomer is 70:30 to 5:95.

3. The photopolymerizable resin composition for sandblast resist as claimed in claim 1, wherein the photoinitiator is included in an amount of 2 to 10 wt. % with respect to the total weight of the photopolymerizable resin composition.

4. The photopolymerizable resin composition for sandblast resist as claimed in claim 1, wherein the photopolymerizable oligomer further comprises 0.01 to 50 wt. % of a plasticizer based on the solid part of the photopolymerizable resin composition.

5. The photopolymerizable resin composition for sandblast resist as claimed in claim 4, wherein the plasticizer is at least one selected from phthalic esters such as dibutyl phthalate, diheptyl phthalate, dioctyl phthalate, or diallyl phthalate; glycol esters such as triethylene glycol diacetate, or tetraethylene glycol diacetate; acid amides such as p-toluene sulfon amide, benzene sulfon amide, or N-n-butyl-benzene sulfon amide; aliphatic dibasic acid esters such as diisopropyl adiphate, dioctyl azelate, or dibutyl maleate; phosphates such as triphenyl phosphate; and tributyl citrate, glycerol triacetate, or dioctyl butyl lauryl 4,5-diepoxycyclohexane-1,2-dicarboxylate.

6. In a photopolymerizable resin composition for sandblast resist, which includes an aqueous alkali-soluble polymer compound, a photopolymerizable oligomer, a photoinitiator, and an additive, the photopolymerizable oligomer comprising a mixture of at least one of a polyalkylene glycol mono(meth)acrylate compound having a terminal alkyl group as selected from compounds represented by the following formulas I to IV, a polyalkylene glycol di(meth)acrylate compound selected from compounds represented by the following formulas V to VIII, and at least one of urethane compounds having a terminal (meth)acrylate group as represented by the following formula IX and derived from a polyether or polyester compound having a terminal hydroxyl group, a diisocyanate compound and a (meth)acrylate compound having a hydroxyl group, 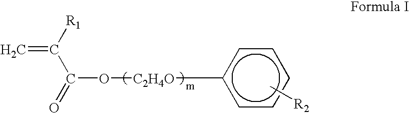
wherein R₁ is hydrogen or methyl; R₂ is an alkyl group having 1 to 30 carbon atoms; and m is an integer from 1 to 30, 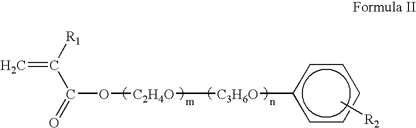
wherein R₁, R₂ and m are as defined in the formula I; and n is an integer from 1 to 30, where n+m is equal to an integer from 2 to 50, 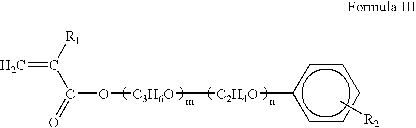
wherein R₁, R₂, m and n are as defined in the formula II, where n+m is equal to an integer from 2 to 50, 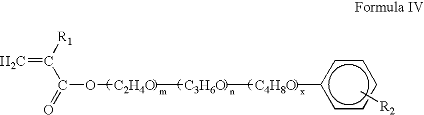
wherein R₁, R₂, m and n are as defined in the formula II; and x is an integer from 1 to 30, where m+n+x is equal to an integer from 6 to 30, 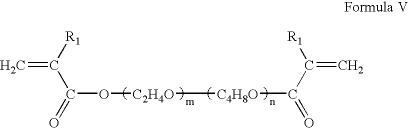
wherein R₁ is hydrogen or methyl; m is an integer from 1 to 30; and n is an integer from 1 to 30, where m+n is equal to an integer from 3 to 34 40, 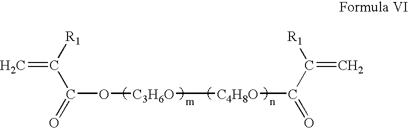
wherein R₁, m and n are as defined in the formula V, where n+m is equal to an integer from 2 to 50, 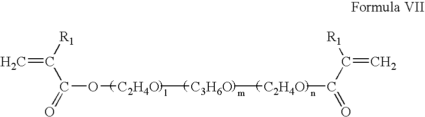
wherein R₁, m and n are as defined in the formula V; and 1 is an integer from 1 to 30, where l+m+n is equal to an integer from 3 to 50, 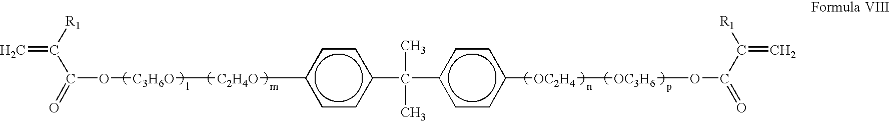
wherein R₁, m, n and 1 are as defined in the formula VII; and p is an integer from 1 to 30, where l+m+n+p is equal to an integer from 4 to 40, 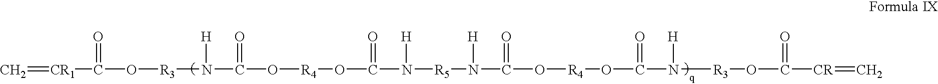
wherein R₁ and R are the same or different and include hydrogen or methyl; R₃ is alkylene or alkylene ether; R₄ is a divalent residual group derived by removing a urethane compound having a terminal (meth)acrylate group as derived from a diisocyanate derivative of two isocyanate groups; R₅ is a divalent residual group derived by removing a diol derivative of a hydroxyl group, the diol derivative having a terminal hydroxyl group and a polyether or polyester as the structure of a main chain thereof; and q is an integer from 1 to 10.

7. The photopolymerizable resin composition for sandblast resist as claimed in claim 6, wherein the weight ratio of the aqueous alkali-soluble polymer compound to the photopolymerizable oligomer is 70:30 to 5:95.

8. The photopolymerizable resin composition for sandblast resist as claimed in claim 6, wherein the photoinitiator is included in an amount of 2 to 10 wt. % with respect to the total weight of the photopolymerizable resin composition.

9. The photopolymerizable resin composition for sandblast resist as claimed in claim 6, wherein the photopolymerizable oligomer further comprises 0.01 to 50 wt. % of a plasticizer based on the solid part of the photopolymerizable resin composition.

10. The photopolymerizable resin composition for sandblast resist as claimed in claim 9, wherein the plasticizer is at least one selected from phthalic esters such as dibutyl phthalate, diheptyl phthalate, dioctyl phthalate, or diallyl phthalate; glycol esters such as triethylene glycol diacetate, or tetraethylene glycol diacetate; acid amides such as p-toluene sulfon amide, benzene sulfon amide, or N-n-butyl-benzene sulfon amide; aliphatic dibasic acid esters such as diisopropyl adiphate, dioctyl azelate, or dibutyl maleate; phosphates such as triphenyl phosphate; and tributyl citrate, glycerol triacetate, or dioctyl butyl lauryl 4,5-diepoxycyclohexane-1,2-dicarboxylate.

11. The photopolymerizable resin composition for sandblast resist as claimed in claim 6, wherein the photopolymerizable resin composition comprises, based on 100 parts by weight of the compound represented by the formula IX, 5 to 70 parts by weight of a compound represented by the formulas I to IV, or the formulas V to VIII.
